(19) United States
(12) Patent Application Publication
(10) Pub. No.: US 2018/0037480 A1
(43) Pub. Date: Feb. 8, 2018

(54) METHOD FOR PRODUCING HYDROGEN WATER

(71) Applicant: MiZ Company Limited, Kanagawa (JP)

(72) Inventors: Ryousuke KUROKAWA, Kanagawa (JP); Fumitake SATOH, Kanagawa (JP); Bunpei SATOH, Kanagawa (JP)

(21) Appl. No.: 15/666,034

(22) Filed: Aug. 1, 2017

(30) Foreign Application Priority Data
Aug. 2, 2016 (JP) 2016-152206

(51) Int. Cl. C02F 1/461; C25B 11/02; C25B 13/00; C25B 1/04

(52) U.S. Cl. CPC C02F 1/46109; C25B 1/04; C25B 11/02; C25B 13/00; C02F 2201/46115; C02F 2201/4614; C02F 2201/4617; C02F 2201/46145; C02F 2001/46138

(57) ABSTRACT

A method of generating hydrogen water of pH 6 to 8 using at least one electrolyzer (2) is provided. The electrolyzer (2) includes a housing (20), a membrane (25) that partitions the inside of the housing (20), an anode chamber (21) and a cathode chamber (22) that are formed inside the housing by being partitioned by the membrane, an anode (23) that is provided to be in contact with a surface of the membrane at the anode chamber side or provided to be separated from the surface via a small space, and a cathode (24) that is provided to be in contact with a surface of the membrane at the cathode chamber side or provided to be separated from the surface of the membrane at the cathode chamber side via a small space. The method includes continuously supplying the cathode chamber with water that contains a mineral component, supplying the anode chamber with water that does not contain a mineral component of which the amount exceeds an impurity content, applying a DC voltage between the anode and the cathode, and delivering hydrogen water generated in the cathode chamber. This method can generate neutral or alkaline hydrogen water.

### BACKGROUND OF THE INVENTION

### 1. Technical Field of the Invention

The present invention relates to a method of generating hydrogen water.

### 2. Description of the Related Art

A hydrogen water generator is known in which an anode electrode plate and a cathode electrode plate are provided inside a container to sandwich a membrane and which is configured to generate hydrogen from the cathode electrode plate by electrolysis of water supplied to the container and generate hydrogen water that contains hydrogen (Patent Document 1: JP2015-223553A).

Patent Document 1: JP2015-223553A

The above conventional hydrogen water generator can generate alkaline hydrogen water of higher than pH 8 because the hydrogen water is generated such that the water supplied to the cathode chamber is allowed to contain the hydrogen generated from the cathode. In some cases, however, hydrogen water of a neutral range of pH 6 to 8 may be needed other than the alkaline hydrogen water. Unfortunately, the above conventional hydrogen water generator is not able to generate hydrogen water of a neutral range of pH 6 to 8.

An object of the present invention is therefore to provide a method of generating hydrogen water of a neutral range of pH 6 to 8 or alkaline hydrogen water of higher than pH 8.

### SUMMARY OF THE INVENTION

According to an aspect of the present invention, the above object is achieved by providing a method of generating hydrogen water of pH 6 to 8 using at least one electrolyzer. The at least one electrolyzer includes a housing, a membrane that partitions an inside of the housing, an anode chamber and a cathode chamber that are formed inside the housing by being partitioned by the membrane, an anode that is provided to be in contact with a surface of the membrane at the anode chamber side, and a cathode that is provided to be in contact with a surface of the membrane at the cathode chamber side. The method includes continuously supplying the cathode chamber with water that contains a mineral component, and

1) supplying the anode chamber with water that does not contain a mineral component of which the amount exceeds an impurity content, or

2) storing, in the anode chamber, water that contains a mineral component or water that does not contain a mineral component of which the amount exceeds an impurity content. The method further includes applying a DC voltage between the anode and the cathode and delivering hydrogen water generated in the cathode chamber.

According to another aspect of the present invention, the above object is achieved by providing a method of generating hydrogen water of pH 6 to 8 using at least one electrolyzer. The at least one electrolyzer includes a housing, a membrane that partitions an inside of the housing from an outside, a cathode chamber that is formed inside the housing by being partitioned by the membrane, an anode that is provided to be in contact with a surface of the membrane located outside the housing, and a cathode that is provided to be in contact with a surface of the membrane at the cathode chamber side. The method includes continuously supplying the cathode chamber with water that contains a mineral component, supplying at least a space between the anode and the membrane with water that does not contain a mineral component of which the amount exceeds an impurity content or water that contains a mineral component, applying a DC voltage between the anode and the cathode, and delivering hydrogen water generated in the cathode chamber.

According to still another aspect of the present invention, the above object is achieved by providing a method of generating hydrogen water of higher than pH 8 using at least one electrolyzer. The at least one electrolyzer includes a housing, a membrane that partitions an inside of the housing, an anode chamber and a cathode chamber that are formed inside the housing by being partitioned by the membrane, an anode that is provided to be in contact with a surface of the membrane at the anode chamber side, and a cathode that is provided to be in contact with a surface of the membrane at the cathode chamber side. The method includes continuously supplying the cathode chamber with water that does not contain a mineral component of which the amount exceeds an impurity content or water that contains a mineral component, supplying the anode chamber with water that contains a mineral component, applying a DC voltage between the anode and the cathode, and delivering hydrogen water generated in the cathode chamber.

According to yet another aspect of the present invention, the above object is achieved by providing a method of generating hydrogen water using at least one electrolyzer. The at least one electrolyzer includes a housing, a membrane that partitions an inside of the housing, an anode chamber and a cathode chamber that are formed inside the housing by being partitioned by the membrane, an anode that is provided to be in contact with a surface of the membrane at the anode chamber side or provided to be separated from the surface via a small space, and a cathode that is provided to be in contact with a surface of the membrane at the cathode chamber side or provided to be separated from the surface of the membrane at the cathode chamber side via a small space. The method includes continuously supplying the cathode chamber with water that does not contain a mineral component of which the amount exceeds an impurity content or water that contains a mineral component, supplying the anode chamber with water that contains a mineral component, applying a DC voltage between the anode and the cathode, and delivering hydrogen water generated in the cathode chamber. The flow rate of water supplied to the anode chamber is adjusted.

According to a further aspect of the present invention, the above object is achieved by providing a method of generating hydrogen water. The method includes preparing at least one electrolyzer. The at least one electrolyzer includes a housing, a membrane that partitions an inside of the housing, an anode chamber and a cathode chamber that are formed inside the housing by being partitioned by the membrane, an anode that is provided to be in contact with a surface of the membrane at the anode chamber side or provided to be separated from the surface via a small space, and a cathode that is provided to be in contact with a surface of the membrane at the cathode chamber side or provided to be separated from the surface of the membrane at the cathode chamber side via a small space. The method further includes supplying the cathode chamber with water of higher than pH 8 generated by electrolysis of water that contains a mineral component, supplying the anode chamber with water generated by electrolysis of water that contains a mineral component, applying a DC voltage between the anode and the cathode, and delivering hydrogen water generated in the cathode chamber.

According to the present invention, when water that does not contain a mineral component is supplied to the anode chamber or water that contains a mineral component is stored in the anode chamber, hydrogen water of pH 6 to 8 can be generated in the cathode chamber. Also when water is supplied to a space between the anode and the membrane in an electrolyzer that has only a cathode chamber, hydrogen water of pH 6 to 8 can be generated in the cathode chamber. On the other hand, when water that contains a mineral component is supplied to the anode chamber, hydrogen water of higher than pH 8 can be generated in the cathode chamber. In an embodiment, alkaline hydrogen water can be generated by dissolving a hydrogen-containing gas into water of higher than pH 8.

### BRIEF DESCRIPTION OF DRAWINGS

FIG. 1 is an overall schematic view illustrating an embodiment of a hydrogen water generator using the method of generating hydrogen water according to the present invention;

FIG. 2A is an overall schematic view illustrating another embodiment of a hydrogen water generator using the method of generating hydrogen water according to the present invention;

FIG. 2B is an overall schematic view illustrating still another embodiment of a hydrogen water generator using the method of generating hydrogen water according to the present invention;

FIG. 3 is an overall schematic view illustrating yet another embodiment of a hydrogen water generator using the method of generating hydrogen water according to the present invention; and

FIG. 4 is an overall schematic view illustrating a further embodiment of a hydrogen water generator using the method of generating hydrogen water according to the present invention.

### DESCRIPTION OF THE PREFERRED EMBODIMENT

A method of generating hydrogen water according to the present invention and a hydrogen water generator 1 using the method according to an embodiment will be described hereinafter. The method of generating hydrogen water and the hydrogen water generator 1 can be used to generate hydrogen water and deliver the generated hydrogen water to living organisms, for example, for the purpose of health maintenance, functional maintenance, disease improvement, functional improvement, health check, and/or functional measurement for living organisms (humans and animals) including cells and organs. Examples of delivery means for the generated hydrogen water to living organisms include delivery by way of oral ingestion, delivery by way of injection and infusion, and delivery by way of adding the hydrogen water to a living organism applicable liquid, such as liquid drug and organ storage liquid, which may be applied to a living organism. Note, however, that the intended use of the generated hydrogen water is not limited to the above because, as described above, the present invention is aimed at providing the method of generating hydrogen water and the hydrogen water generator 1 which are able to selectively generate hydrogen water of a neutral range of pH 6 to 8 and alkaline hydrogen water of higher than pH 8.

### First Embodiment (Method of Generating Neutral Hydrogen Water)

The method of generating hydrogen water according to a first embodiment of the present invention is a method of generating hydrogen water of a neutral range of pH6 to 8. Three possible forms is of this method can be considered:

(1) a method of generating hydrogen water of a neutral range of pH 6 to 8 using at least one electrolyzer 2, the at least one electrolyzer 2 comprising: a housing 20; a membrane 25 that partitions an inside of the housing 20; an anode chamber 21 and a cathode chamber 22 that are formed inside the housing 20 by being partitioned by the membrane 25; an anode 23 that is provided to be in contact with a surface of the membrane 25 at the anode chamber 22 side or provided to be separated from the surface via a small space; and a cathode 24 that is provided to be in contact with a surface of the membrane 25 at the cathode chamber 22 side or provided to be separated from the surface of the membrane 25 at the cathode chamber 22 side via a small space, the method comprising: continuously supplying the cathode chamber 22 with water that contains a mineral component; supplying the anode chamber 21 with water that does not contain a mineral component of which the amount exceeds an impurity content; applying a DC voltage between the anode 23 and the cathode 24; and delivering hydrogen water generated in the cathode chamber 22;

(2) a method of generating hydrogen water of a neutral range of pH 6 to 8 using at least one electrolyzer 2, the at least one electrolyzer 2 comprising: a housing 20; a membrane 25 that partitions an inside of the housing 20; an anode chamber 21 and a cathode chamber 22 that are formed inside the housing 20 by being partitioned by the membrane 25; an anode 23 that is provided to be in contact with a surface of the membrane 25 at the anode chamber 21 side or provided to be separated from the surface via a small space; and a cathode 24 that is provided to be in contact with a surface of the membrane 25 at the cathode chamber 22 side or provided to be separated from the surface of the membrane 25 at the cathode chamber 22 side via a small space, the method comprising: continuously supplying the cathode chamber 22 with water that contains a mineral component; storing, in the anode chamber 21, water that contains a mineral component; applying a DC voltage between the anode 23 and the cathode 24; and delivering hydrogen water generated in the cathode chamber 22; and

(3) a method of generating hydrogen water of a neutral range of pH 6 to 8 using at least one electrolyzer 2, the at least one electrolyzer 2 comprising: a housing 20; a membrane 25 that partitions an inside of the housing 20 from an outside; a cathode chamber 22 that is formed inside the housing 20 by being partitioned by the membrane 25; an anode 23 that is provided to be in contact with a surface of the membrane 25 located outside the housing 20 or provided to be separated from the surface via a small space; and a cathode 24 that is provided to be in contact with a surface of the membrane 25 at the cathode chamber 22 side or provided to be separated from the surface of the membrane 25 at the cathode chamber 22 side via a small space, the method comprising: continuously supplying the cathode chamber 22 with water that contains a mineral component; supplying at least a space between the anode 23 and the membrane 25 with water that does not contain a mineral component of which the amount exceeds an impurity content or water that contains a mineral component; applying a DC voltage between the anode 23 and the cathode 24; and delivering hydrogen water generated in the cathode chamber 22.

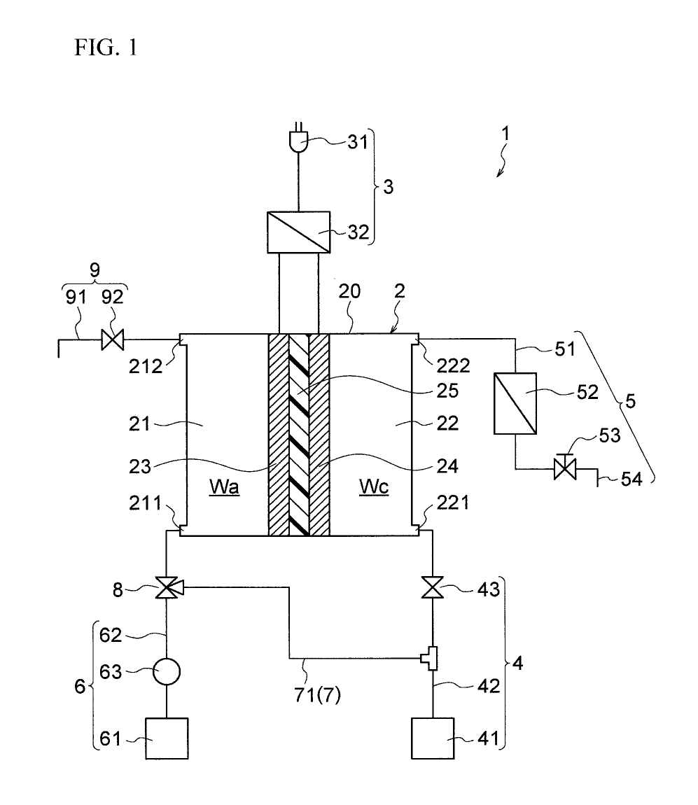

Reference numerals in the above (1) to (3) correspond to those denoted for hydrogen water generators illustrated in FIG. 1 to FIG. 3. The term “neutral” refers generally to a liquid of pH≈7, but the “neutral range” as used in the present description and claims refers to a range of pH 6 to 8 which includes the neutral pH (≈7).

### Second Embodiment (Method of Generating Alkaline Hydrogen Water)

The method of generating hydrogen water according to a second embodiment of the present invention is a method of generating alkaline hydrogen water of higher than pH 8. Two possible forms of this method can be considered:

(1) a method of generating alkaline hydrogen water of higher than pH 8 using at least one electrolyzer 2, the at least one electrolyzer 2 comprising: a housing 20; a membrane 25 that partitions an inside of the housing 20; an anode chamber 21 and a cathode chamber 22 that are formed inside the housing 20 by being partitioned by the membrane 25; an anode 23 that is provided to be in contact with a surface of the membrane 25 at the anode chamber 21 side or provided to be separated from the surface via a small space; and a cathode 24 that is provided to be in contact with a surface of the membrane 25 at the cathode chamber 22 side or provided to be separated from the surface of the membrane 25 at the cathode chamber 22 side via a small space, the method comprising: continuously supplying the cathode chamber 22 with water that contains a mineral component; supplying the anode chamber 21 with water that contains a mineral component; applying a DC voltage between the anode 23 and the cathode 24; and delivering hydrogen water generated in the cathode chamber 22; and

(2) a method of dissolving a hydrogen-containing gas into alkaline water of higher than pH 8.

Reference numerals in the above (1) and (2) correspond to those denoted for hydrogen water generators illustrated in FIG. 1 to FIG. 3. The term “alkaline” refers generally to a liquid of pH>7, but the “alkaline hydrogen water” as used in the present description and claims refers to alkaline hydrogen water of higher than pH 8. In particular, alkaline hydrogen water of pH 9.2 to 9.8 is preferred.

### <<Example of Hydrogen Water Generator Using Method of Generating Hydrogen Water>>

An example of a hydrogen water generator will be described which uses the above-described method of generating neutral hydrogen water according to the first embodiment and method of generating alkaline hydrogen water according to the second embodiment. It is to be noted that the method of generating hydrogen water of the present invention is not limited to only being realized using the hydrogen water generator described below.

FIG. 1 is an overall schematic view illustrating an example of the hydrogen water generator 1 using the method of generating hydrogen water according to the present invention. The hydrogen water generator 1 of this example comprises an electrolyzer 2, an electric power source 3 that applies a DC voltage between a pair of anode 23 and cathode 24 provided in the electrolyzer 2, a first supply system 4 that continuously supplies a cathode chamber 22 in the electrolyzer 2 with water that contains a mineral component or water that does not contain a mineral component of which the amount exceeds an impurity content, a water delivery system 5 that delivers the hydrogen water generated in the cathode chamber 22, a second supply system 6 that supplies an anode chamber 21 in the electrolyzer 2 with water that does not contain a mineral component of which the amount exceeds an impurity content, a third supply system 7 that supplies the anode chamber 21 with water that contains a mineral component, and a switch 8 that switches the water supply system to the anode chamber 21 at least between the second supply system 6 and the third supply system 7.

The electrolyzer 2 is configured to include a housing 20, the anode chamber 21 which is formed in the housing 20 and into which water for electrolysis Wa is introduced, the cathode chamber 22 which is provided separately from the anode chamber 21 in the housing 20 and into which water for electrolysis Wc is introduced, a membrane 25 (also referred to as a “cation exchange membrane,” hereinafter) provided between the anode chamber 21 and the cathode chamber 22 in the housing 20, the anode 23 provided in the anode chamber 21, and the cathode 24 provided in the cathode chamber 22. The housing 20 may be formed of an electrically insulating material, such as plastic, and configured such that the sealing state for water and gas can be maintained except an inlet 211 and outlet 212 for the water for electrolysis Wa and an inlet 221 and outlet 222 for the water for electrolysis Wc, which will be described later.

The inside of the housing 20 is partitioned by the cation exchange membrane 25 into the anode chamber 21 and the cathode chamber 22. In the present embodiment, each of the pair of anode 23 and cathode 24 is formed in a flat plate-like shape and provided to be in contact with a surface of the cation exchange membrane 25 or provided to be separated from the surface via a small space. As used herein, the “small space” refers to a space that is formed to such an extent that a water film can be formed between the anode 23 or cathode 24 and the cation exchange membrane 25. The anode 23 provided in the anode chamber 21 into which the water for electrolysis Wa is introduced is connected to the positive terminal (+) of the DC electric power source, and the cathode 24 provided in the cathode chamber 22 is connected to the negative terminal (−) of the DC electric power source.

The cation exchange membrane 25 of the present embodiment is a cation exchange membrane that is permeable to hydrogen ions and mineral component ions but impermeable to hydroxy ions. In consideration of necessary properties, such as the ion conductivity, physical strength, gas barrier property, chemical stability, electrochemical stability and thermal stability, there may preferably be used an all fluorine-based sulfonic acid membrane that comprises sulfonic groups as the electrolyte groups. Examples of such a membrane include a membrane of Nafion (registered trademark, a DuPont product) which is a copolymer membrane of tetrafluoroethylene and perfluorovinyl ether having a sulfonic group, a membrane of Flemion (registered trademark, available from ASAHI GLASS CO., LTD.), and a membrane of Aciplex (registered trademark, available from Asahi Kasei Corporation).

The pair of anode 23 and cathode 24 used in the present embodiment may be those using titanium plates as base materials which are each plated with one or more layers of noble metal selected from the group of platinum, iridium, palladium and the like. However, the present invention is not limited to using such electrode plates, and solid stainless steel plates may also be used without plating. As described above, the anode 23 provided in the anode chamber 21 and the cathode 24 provided in the cathode chamber 22 may not necessarily be pressed and fixed to the cation exchange membrane 25 and may have a small space with the cation exchange membrane 25 to such an extent that a water film is formed therein.

The electric power source 3 is configured to include a plug 31 that is connected to a commercial AC power source or the like, and an AC/DC converter 32 that converts the commercial AC current to a DC current. Alternatively or additionally, a DC power source such as a primary or secondary battery may be used as substitute for or in addition to the plug 31 and the AC/DC converter 32 in order to provide a portable hydrogen water generator 1 (i.e. a hydrogen water generator 1 that can be carried anywhere).

The housing 20 of the electrolyzer 2 includes the inlet 211 provided at the lower part of the anode chamber 21 for the water for electrolysis Wa, the outlet 212 provided at the upper part of the anode chamber 21 for the water for electrolysis Wa, the inlet 221 provided at the lower part of the cathode chamber 22 for the water for electrolysis Wc, and the outlet 222 provided at the upper part of the cathode chamber 22 for the water for electrolysis Wc. The inlet 221 of the cathode chamber 22 is connected to the first supply system 4 which continuously supplies the cathode chamber 22 in the electrolyzer 2 with water that contains a mineral component, and the outlet 222 of the cathode chamber 22 is connected to the water delivery system 5 which delivers the hydrogen water generated in the cathode chamber 22.

The first supply system 4 includes a tap water source 41 such as a water tap, pipework 42, and an opening/closing valve 43. When the valve 43 is opened, the first supply system 4 continuously supplies the tap water, which contains a mineral component, to the cathode chamber 22. Although not illustrated, when the cathode chamber 22 is supplied with water that is substantially free from a mineral component, a softening apparatus or deionizer may be provided, for example, upstream or downstream the valve 43. The softening apparatus or deionizer has an ion-exchange resin or reverse osmosis membrane that removes mineral components contained in the tap water. The water delivery system 5 includes pipework 51, a dissolution part 52, a flow rate regulating valve 53, and a water delivery outlet 54. When the flow rate regulating valve 53 is opened, the water delivery system 5 delivers the hydrogen water as desired. The dissolution part 52 is a tubular body having a larger inner diameter than the inner diameter of the pipework 51 and includes a mixing body, such as a membrane filter, which has fine pores and is provided inside the dissolution part 52. When the gas-liquid mixture of water and the hydrogen gas generated from the cathode chamber 22 passes through the fine pores of the mixing body, such as a membrane filter, the hydrogen gas becomes fine bubbles thereby to increase the contact surface area with the water. Moreover, the hydrogen gas of fine bubbles and the water are pressurized by the pressurizing force of the tap water source 41 and the opening degree of the flow rate regulating valve 53, and the hydrogen concentration can therefore be increased. The hydrogen water of a high concentration thus obtained is supplied from the water delivery outlet 54 to a desired site. In an alternative embodiment, the dissolution part 52 may be omitted as necessary.

The second supply system 6 includes a tank 61, pipework 62, and a pump 63. The tank 61 stores water that does not contain a mineral component of which the amount exceeds an impurity content. The pipework 62 has an end connected to the switch 8 which is a three-way valve. In contrast, the third supply system 7 comprises pipework 71 that is branched from the pipework 42 of the first supply system 4. The pipework 71 has an end connected to the switch 8 which is a three-way valve. The switch 8, which is a three-way valve, switches the water supply system to the anode chamber 21 at least between the second supply system 6 and the third supply system 7. That is, the switch 8 switches between a position at which the inlet 211 of the anode chamber 21 is supplied with the water which is stored in the tank 61 and is substantially free from a mineral component and a position at which the inlet 211 of the anode chamber 21 is supplied with the water which is from the tap water source 41 and contains a mineral component. In the example illustrated in FIG. 1, the third supply system 7 is configured to share the first supply system 4, but may also be configured to be independent of the first supply system 4 by providing another tap water source separate from the tap water source 41 of the first supply system 4. In an alternative embodiment, instead of using tap water, a tank may be used to store water that contains a mineral component and the stored water may be supplied from the tank to the anode chamber 21. In an embodiment, the anode chamber 21 may be manually supplied with water that contains a mineral component or water that is substantially free from a mineral component. In the method of generating hydrogen water according to the present invention, a first mode refers to a mode in which the anode chamber 21 is supplied with water that does not contain a mineral component of which the amount exceeds an impurity content, and a second mode refers to a mode in which the anode chamber 21 is supplied with water that contains a mineral component. To realize the first and second modes and to switch between them, the second supply system 6, the third supply system 7, and the switch 8 may be used, or otherwise an operator may manually perform the operation without providing the second supply system 6, the third supply system 7, and the switch 8.

The water for electrolysis Wa, Wc used in the hydrogen water generator 1 of the present embodiment is water from which hydrogen gas can be generated at the cathode 24 owing to an electrolysis reaction of the water. Examples of water that contains a mineral component (such as zinc, potassium, calcium, chromium, selenium, iron, copper, sodium, magnesium, manganese, molybdenum, iodine, and phosphorus) typically include tap water and clean water. Examples of water that does not contain a mineral component of which the amount exceeds an impurity content (also referred to as “water that is substantially free from a mineral component,” herein) include purified water, ion-exchanged water, RO water, distilled water, and deionized water.

A drain system 9 is connected to the outlet 212 of the anode chamber 21. The drain system 9 includes pipework 91 and an opening/closing valve 92. The valve 92 can be opened to discharge the water for electrolysis Wa from the anode chamber 21 when the anode chamber 21 is supplied with water that contains a mineral component after performing the electrolysis while supplying the anode chamber 21 with water that is substantially free from a mineral component, or when the anode chamber 21 is supplied with water that is substantially free from a mineral component after performing the electrolysis while supplying the anode chamber 21 with water that contains a mineral component. The valve 92 can also be opened to discharge the water for electrolysis Wa from the anode chamber 21 in the middle of the electrolysis in which the anode chamber 21 is supplied with water that contains a mineral component. When water that contains a mineral component is stored in the anode chamber 21, the switch 8 may be closed to stop the water supply from the tap water source 41.

Actions will then be described.

When the switch 8 is set at a position of supplying the water from the tap water source 41 which contains a mineral component so that both the anode chamber 21 and cathode chamber 22 of the hydrogen water generator 1 are supplied with the water which contains a mineral component, and a DC voltage is applied between the anode 23 and the cathode 24, the following reactions occur at the anode 23 and the cathode 24.

Anode: 2OH⁻→H₂O+O₂/2+2e⁻(or H₂O−2e⁻→2H⁺+O₂/2)

Cathode: 2H₂O+2e⁻→H₂+2OH⁻ [Formulae 1]

Here, in the cathode chamber 22, in addition to the mineral component contained in the water supplied to the cathode chamber 22, the mineral component supplied to the anode chamber 21 passes through the cation exchange membrane 25 and moves into the cathode chamber 22. At the same time, hydrogen ions in the anode chamber 21 also pass through the cation exchange membrane 25 and move into the cathode chamber 22. Then, in the cathode chamber 22, hydroxy ions OH⁻ and ions of the mineral component (such as calcium ions Ca²⁺ and magnesium ions Mg²⁺) are ionically combined to generate a compound, such as Ca(OH)₂ and Mg(OH)₂, which exhibits alkalinity. During this reaction, hydrogen ions H⁺, which have moved from the anode chamber 21 to the cathode chamber 22, and hydroxy ions OH⁻ are combined to be water, but the delivered water from the cathode chamber 22 exhibits alkalinity because the hydrogen-ion concentration is lower than the ion concentration of the mineral component. This applies to the case in which the anode chamber 21 is supplied with water that contains a mineral component and the cathode chamber 22 is supplied with water that is substantially free from a mineral component. That is, in the cathode chamber 22, the water supplied to the cathode chamber 22 is free from a mineral component, but the mineral component supplied to the anode chamber 21 passes through the cation exchange membrane 25 and moves into the cathode chamber 22. Then, in the cathode chamber 22, hydroxy ions OH⁻ and ions of the mineral component (such as calcium ions Ca²⁺ and magnesium ions Mg²⁺) are ionically combined to generate a compound, such as Ca(OH)₂ and Mg(OH)₂, which exhibits alkalinity. During this reaction, hydrogen ions H⁺, which have moved from the anode chamber 21 to the cathode chamber 22, and hydroxy ions OH⁻ are combined to be water, but the delivered water from the cathode chamber 22 exhibits alkalinity because the hydrogen-ion concentration is lower than the ion concentration of the mineral component.

In contrast, when the switch 8 is set at a position of supplying the water stored in the tank 61 which is substantially free from a mineral component so that the cathode chamber 22 of the hydrogen water generator 1 is supplied with the water which contains a mineral component while the anode chamber 21 is supplied with the water which is substantially free from a mineral component, and a DC voltage is applied between the anode 23 and the cathode 24, the above reactions occur at the anode 23 and the cathode 24. Here, in the cathode chamber 22, the mineral component (such as calcium ions Ca²⁺ and magnesium ions Mg²⁺) contained in the water supplied to the cathode chamber 22 and hydroxy ions OH⁻ are ionically combined to generate a compound, such as Ca(OH)₂ and Mg(OH)₂, which exhibits alkalinity. However, at the same time, hydrogen ions in the anode chamber 21 pass through the cation exchange membrane 25 and move into the cathode chamber 22. Then, in the cathode chamber 22, hydrogen ions H⁺, which have moved from the anode chamber 21 to the cathode chamber 22, and hydroxy ions OH⁻ are combined to be water. Due to this reaction, the delivered water from the cathode chamber 22 comes close to neutrality from alkalinity. This applies to the case in which the anode chamber 21 is supplied with water that contains a mineral component and the cathode chamber 22 is supplied with water that is substantially free from a mineral component. That is, a compound, such as Ca(OH)₂ and Mg(OH)₂, which exhibits alkalinity is not generated because the water supplied to the cathode chamber 22 does not contain a mineral component. In addition, hydrogen ions H⁺, which have moved from the anode chamber 21 to the cathode chamber 22, and hydroxy ions OH⁻ are combined to be water. The delivered water from the cathode chamber 22 therefore exhibits neutrality.

In an embodiment, the switch 8 is set at a position of supplying the water from the tap water source 41 which contains a mineral component so that both the anode chamber 21 and cathode chamber 22 of the hydrogen water generator 1 are supplied with the water which contains a mineral component, but the switch 8 is then closed to stop the water supply from the tap water source 41 and store the water which contains a mineral component in the anode chamber 21 (i.e., water is not supplied). Then, when a DC voltage is applied between the anode 23 and the cathode 24, the above reactions occur at the anode 23 and the cathode 24.

Here, in the initial stage of the cathode chamber 22, in addition to the mineral component contained in the water supplied to the cathode chamber 22, the mineral component supplied to the anode chamber 21 passes through the cation exchange membrane 25 and moves into the cathode chamber 22. At the same time, hydrogen ions in the anode chamber 21 also pass through the cation exchange membrane 25 and move into the cathode chamber 22. Then, in the cathode chamber 22, hydroxy ions OH⁻ and ions of the mineral component (such as calcium ions Ca²⁺ and magnesium ions Mg²⁺) are ionically combined to generate a compound, such as Ca(OH)₂ and Mg(OH)₂, which exhibits alkalinity. During this reaction, hydrogen ions H⁺, which have moved from the anode chamber 21 to the cathode chamber 22, and hydroxy ions OH⁻ are combined to be water, but the delivered water from the cathode chamber 22 exhibits alkalinity because the hydrogen-ion concentration is lower than the ion concentration of the mineral component.

However, the mineral component contained in the water stored in the anode chamber 21 decreases with time and finally becomes zero. As time passes, therefore, the situation becomes the same as the case in which the anode chamber 21 is supplied with water that is substantially free from a mineral component, and the delivered water from the cathode chamber 22 exhibits neutrality. Due to a similar action, when the flow rate of water supplied to the anode chamber 21 which contains a mineral component is reduced, the delivered water from the cathode chamber 22 exhibits neutrality as in the case of storing water that contains a mineral component in the anode chamber 21.

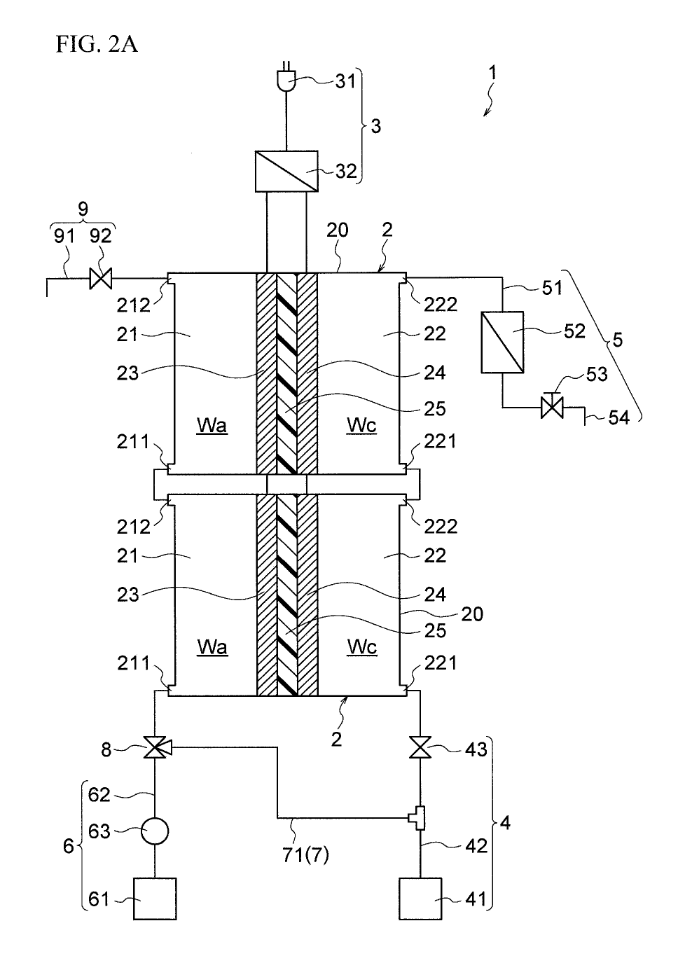

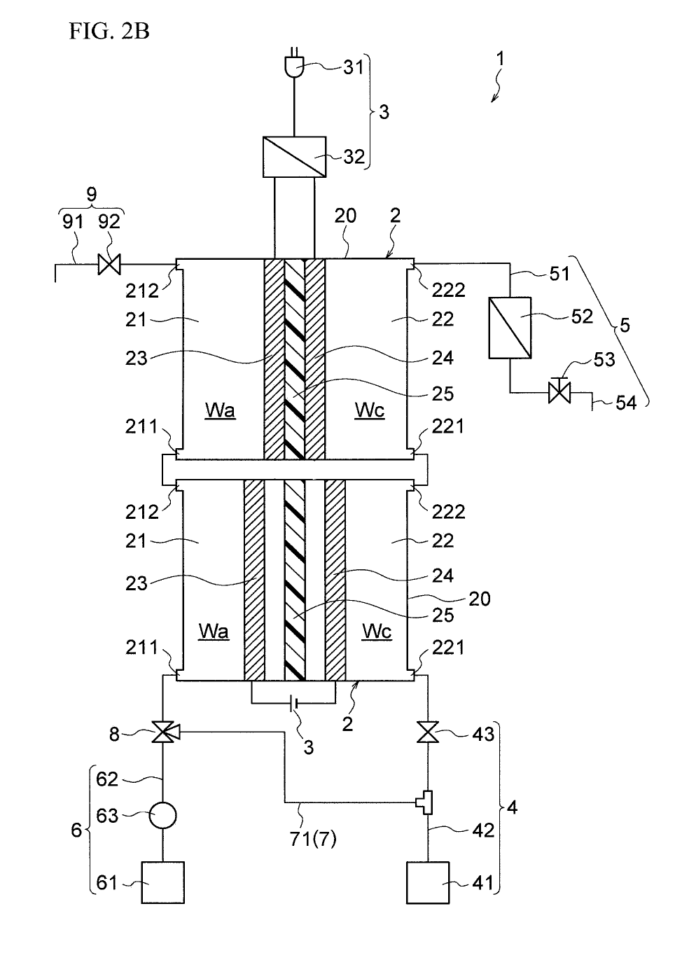

FIG. 2A is an overall schematic view illustrating another embodiment of a hydrogen water generator using the method of generating hydrogen water according to the present invention. The hydrogen water generator 1 illustrated in FIG. 2A is configured such that two electrolyzers 2 are connected in series, and other configuration is the same as that of the embodiment illustrated in FIG. 1, so the description will be borrowed herein. FIG. 2B is an overall schematic view illustrating still another embodiment of a hydrogen water generator using the method of generating hydrogen water according to the present invention. The hydrogen water generator 1 illustrated in FIG. 2B is also configured such that two electrolyzers 2 are connected in series, but is different from the embodiment illustrated in FIG. 2A in that the electrolyzer 2 of the first stage is another type of electrolyzer in which the anode 23 and the cathode 24 are not in contact with the cation exchange membrane 25. Water generated in the cathode chamber 22 of such an electrolyzer 2 of the first stage exhibits alkarility while water generated in the anode chamber 21 exhibits acidity, but alkaline water may be supplied to the cathode chamber 22 of the electrolyzer 2 of the second stage thereby to enable delivery of alkaline hydrogen water.

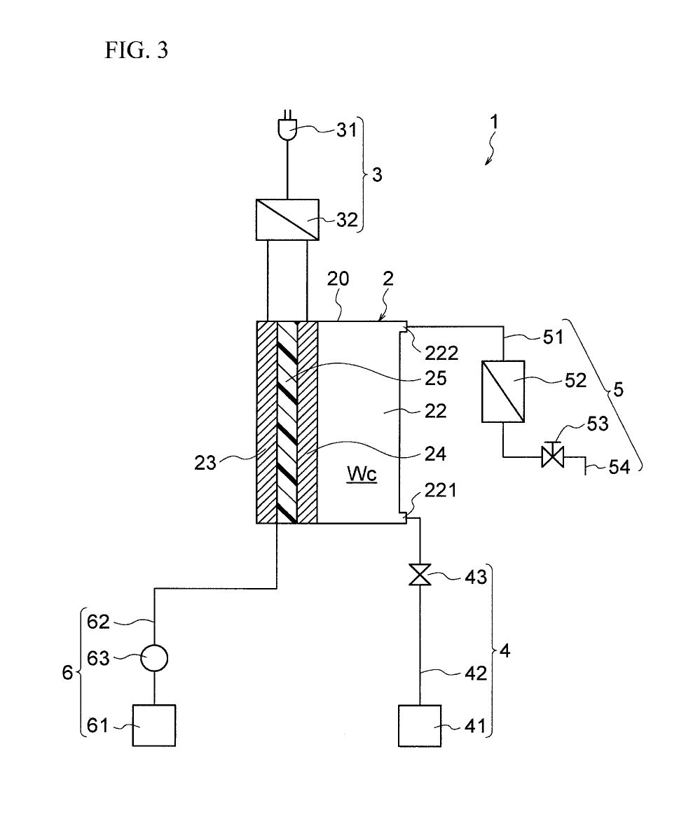

FIG. 3 is an overall schematic view illustrating yet another embodiment of a hydrogen water generator using the method of generating hydrogen water according to the present invention. The hydrogen water generator 1 of this example comprises an electrolyzer 2, an electric power source 3 that applies a DC voltage between a pair of anode 23 and cathode 24 provided outside and inside the electrolyzer 2, a first supply system 4 that continuously supplies a cathode chamber 22 in the electrolyzer 2 with water that contains a mineral component or water that does not contain a mineral component of which the amount exceeds an impurity content, a water delivery system 5 that delivers the hydrogen water generated in the cathode chamber 22, and a second supply system 6 that supplies a space between the anode 23 provided outside the electrolyzer 2 and the membrane 25 with water that contains a mineral component or water that does not contain a mineral component of which the amount exceeds an impurity content.

The electrolyzer 2 is configured to include a housing 20, the cathode chamber 22 which is formed in the housing 20 and into which water for electrolysis Wc is introduced, a membrane 25 (also referred to as a “cation exchange membrane,” hereinafter) that partitions the inside of the housing 20 from the outside, the anode 23 provided outside the housing 20, and the cathode 24 provided in the cathode chamber 22 which is the inside of the housing 20. The housing 20 may be formed of an electrically insulating material, such as plastic, and configured such that the sealing state for water and gas can be maintained except an inlet 221 and outlet 222 for the water for electrolysis Wc. The electrolyzer 2 is basically the same as those illustrated in FIG. 1 and FIG. 2 except that the anode chamber 21 is omitted.

The first supply system 4 includes a tap water source 41 such as a water tap, pipework 42, and an opening/closing valve 43. When the valve 43 is opened, the first supply system 4 continuously supplies the tap water, which contains a mineral component, to the cathode chamber 22. Although not illustrated, when the cathode chamber 22 is supplied with water that is substantially free from a mineral component, a softening apparatus or deionizer may be provided, for example, upstream or downstream the valve 43. The softening apparatus or deionizer has an ion-exchange resin or reverse osmosis membrane that removes mineral components contained in the tap water. The water delivery system 5 includes pipework 51, a dissolution part 52, a flow rate regulating valve 53, and a water delivery outlet 54. When the flow rate regulating valve 53 is opened, the water delivery system 5 delivers the hydrogen water as desired. The dissolution part 52 is a tubular body having a larger inner diameter than the inner diameter of the pipework 51 and includes a mixing body, such as a membrane filter, which has fine pores and is provided inside the dissolution part 52. When the gas-liquid mixture of water and the hydrogen gas generated from the cathode chamber 22 passes through the fine pores of the mixing body, such as a membrane filter, the hydrogen gas becomes fine bubbles thereby to increase the contact surface area with the water. Moreover, the hydrogen gas of fine bubbles and the water are pressurized by the pressurizing force of the tap water source 41 and the opening degree of the flow rate regulating valve 53, and the hydrogen concentration can therefore be increased. The hydrogen water of a high concentration thus obtained is supplied from the water delivery outlet 54 to a desired site. In an alternative embodiment, the dissolution part 52 may be omitted as necessary.

The second supply system 6 includes a tank 61, pipework 62, and a pump 63. The tank 61 stores either of water that contains a mineral component or water that does not contain a mineral component of which the amount exceeds an impurity content. The pipework 62 has an end provided toward a space between the anode 23 and the cation exchange membrane 25. The end of the pipework 62 continuously or intermittently supplies such water to the space between the anode 23 and the cation exchange membrane 25. In an embodiment, the space between the anode 23 and the cation exchange membrane 25 may be manually supplied with water that contains a mineral component or water that is substantially free from a mineral component.

Actions will then be described.

When the cathode chamber 22 of the hydrogen water generator 1 is supplied with the water which contains a mineral component while the space between the anode 23 and the cation exchange membrane 25 is supplied with the water which contains a mineral component or the water which is substantially free from a mineral component, and a DC voltage is applied between the anode 23 and the cathode 24, the above reactions occur at the anode 23 and the cathode 24. Here, in the cathode chamber 22, the mineral component (such as calcium ions Ca²⁺ and magnesium ions Mg²⁺) contained in the water supplied to the cathode chamber 22 and hydroxy ions OH⁻ are ionically combined to generate a compound, such as Ca(OH)₂ and Mg(OH)₂, which exhibits alkalinity. However, at the same time, hydrogen ions contained in the water supplied to the space between the anode 23 and the cation exchange membrane 25 pass through the cation exchange membrane 25 and move into the cathode chamber 22. Then, in the cathode chamber 22, hydrogen ions H⁺, which have moved from that space to the cathode chamber 22, and hydroxy ions OH⁻ are combined to be water. Due to this reaction, the delivered water from the cathode chamber 22 comes close to neutrality from alkalinity. This applies to the case in which the space between the anode 23 and the cation exchange membrane 25 is supplied with water that contains a mineral component and the case in which the space between the anode 23 and the cation exchange membrane 25 is supplied with water that is substantially free from a mineral component. This is because, even when the space between the anode 23 and the cation exchange membrane 25 is supplied with water that contains a mineral component, its content is very small and decreases with time.

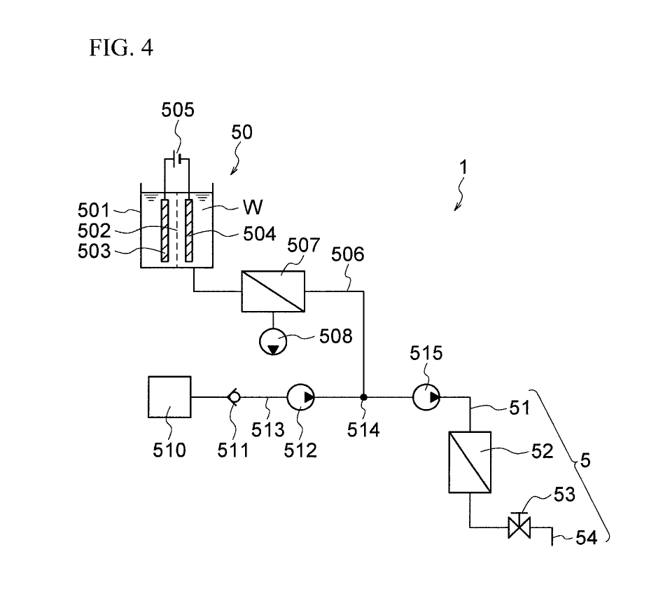

FIG. 4 is an overall schematic view illustrating a further embodiment of a hydrogen water generator using the method of generating hydrogen water according to the present invention. The hydrogen water generator 1 of this example uses a method of generating alkaline hydrogen water by dissolving a hydrogen-containing gas into alkaline water. The alkaline hydrogen water generator 1 of this example uses an electrolysis water generator 50 as the supply source of alkaline water. The electrolysis water generator 50 comprises an electrolyzer 501, a membrane 502, a pair of anode plate 503 and cathode plate 504 that sandwich the membrane 502, a DC electric power source 505 that supplies a DC voltage between the anode plate 503 and the cathode plate 504, and water for electrolysis W that is stored in the electrolyzer 501. A liquid supply pipe 506 for the alkaline water is provided with a degassing module 507 and a vacuum pump 508, which are used to degass the gas contained in the alkaline water.

A hydrogen supply source 510 is provided to supply gas that contains a hydrogen component as the main component (also referred to as a “hydrogen-containing gas,” herein). Examples of the hydrogen supply source 510 include a hydrogen gas cylinder, hydrogen storing alloy, fuel reformer, and electrolysis water generator. The hydrogen-containing gas supplied from such a hydrogen supply source 510 is sent to a junction part 514 via a hydrogen supply pipe 513. The hydrogen supply pipe 513 is provided with a check valve 511, and the hydrogen-containing gas having passed through the check valve 511 does not return to the hydrogen supply source 510. In addition, to regulate the supply pressure of the hydrogen-containing gas from the hydrogen supply source 510 to the junction part 514, the hydrogen supply pipe 513 is provided with a fluid pressurization pump 512.

The junction part 514 is composed of a piping joint with the hydrogen supply pipe 513 and the liquid supply pipe 506. When reaching the junction part 514, the hydrogen-containing gas and the liquid flow into a gas-liquid mixing pipe 51, which is provided with a fluid pressurization pump 515. This pump 515 pressurizes and sends the hydrogen-containing gas and the liquid toward the downstream side. A dissolution part 52 is provided at the downstream side of the fluid pressurization pump 515 on the gas-liquid mixing pipe 51. In addition, a flow rate regulating valve 53 is provided at the downstream side of the dissolution part 52 on the gas-liquid mixing pipe 51.

The dissolution part 52 is a tubular body having a larger inner diameter than the inner diameter of the gas-liquid mixing pipe 51 and includes a mixing body, such as a membrane filter, which has fine pores and is provided inside the dissolution part 52. When the gas-liquid mixture of the hydrogen-containing gas and the liquid passes through the fine pores of the mixing body, such as a membrane filter, the hydrogen-containing gas becomes fine bubbles thereby to increase the contact surface area with the liquid. Moreover, the hydrogen-containing gas and the liquid are pressurized by the pressurizing force of the fluid pressurization pump 515 and the opening degree of the flow rate regulating valve 53, and the hydrogen concentration can therefore be increased. The hydrogen-containing liquid of a high concentration thus obtained is supplied from the water delivery outlet 54 to a desired site.

### Examples

Hydrogen concentration DH (mg/L) and pH of water generated in the cathode chamber 22 were measured when using the Kamakura city tap water (calcium hardness of 42.5 ppm and magnesium hardness of 18.5 ppm as the U.S. water hardness and pH 7.1) as the water containing a mineral component, using purified water (deionized water cartridge G-20 available from ORGANO CORPORATION) as the water substantially free from a mineral component, using the hydrogen water generator 1 of FIG. 1 having one electrolyzer 2, using the hydrogen water generator 1 of FIG. 2 having two electrolyzers 2, and changing the current flowing through the cathode 24, the type of water in the anode chamber 21, the flow rate of water in the cathode chamber 22, and the water pressure in the cathode chamber 22. Results are listed in Table 1.

TABLE 1

| | | Cathode water | Cathode inner | DH | |
|---|---|---|---|---|---|
| Current | Anode water | flow rate | pressure (MPa) | (mg/L) | pH |
| 6 A × 1 bath | Purified water (stored) | 1.0 L/min | 0.1 | 1.3 | 7.09 |
| | | | 0.2 | 1.6 | 6.93 |
| | | | 0.3 | 1.8 | 6.91 |
| 6 A × 1 bath | Tap water flowing | 1.0 L/min | 0.1 | 1.3 | 8.42 |
| | Flow rate of 1.0 L/min | | 0.2 | 1.5 | 8.42 |
| | Anode chamber inner pressure = | | 0.3 | 1.8 | 8.21 |
| | Cathode chamber inner pressure | | | | |
| 6 A × 1 bath | Purified water (stored) | 2.0 L/min | 0.1 | 0.9 | 7.09 |
| | | | 0.2 | 1.0 | 6.99 |
| | | | 0.3 | 1.1 | 6.97 |
| 6 A × 1 bath | Tap water flowing | 2.0 L/min | 0.1 | 0.9 | 7.88 |
| | Flow rate of 2.0 L/min | | 0.2 | 1.1 | 8.38 |
| | Anode chamber inner pressure = | | 0.3 | 1.1 | 9.32 |
| | Cathode chamber inner pressure | | | | |
| 6 A × 2 baths | Purified water (stored) | 1.0 L/min | 0.1 | 1.8 | 7.09 |
| | | | 0.2 | 2.2 | 6.98 |
| | | | 0.3 | 2.5 | 6.92 |
| 6 A × 2 baths | Tap water flowing | 1.0 L/min | 0.1 | 1.9 | 9.36 |
| | Flow rate of 1.0 L/min | | 0.2 | 2.2 | 9.85 |
| | Anode chamber inner pressure = | | 0.3 | 2.5 | 9.68 |
| | Cathode chamber inner pressure | | | | |
| 6 A × 2 baths | Purified water (stored) | 2.0 L/min | 0.1 | 1.4 | 7.11 |
| | | | 0.2 | 1.8 | 7.04 |
| | | | 0.3 | 1.9 | 7.03 |
| 6 A × 2 baths | Tap water flowing | 2.0 L/min | 0.1 | 1.5 | 9.57 |
| | Flow rate of 2.0 L/min | | 0.2 | 1.7 | 9.86 |
| | Anode chamber inner pressure = | | 0.3 | 1.8 | 9.67 |
| | Cathode chamber inner pressure | | | | |

### <<Consideration>>

When the water supplied to the anode chamber 21 is water that is substantially free from a mineral component, pH of the hydrogen water generated in the cathode chamber 22 is 6.91 to 7.11, that is, neutral. In contrast, when the water supplied to the anode chamber 21 is water that contains a mineral component (specifically, tap water), pH of the hydrogen water generated in the cathode chamber 22 is 7.88 to 9.86, that is, alkaline.

When one electrolyzer 2 is used as illustrated in FIG. 1 and the water supplied to the anode chamber 21 is water that is substantially free from a mineral component, the concentration DH of hydrogen water is 1.6 mg/L or more with the setting in which the current flowing through the cathode 24 is 6 A or more, the supply amount of water to the cathode chamber 22 is 1.0 L/min or less, and the pressure of water supplied to the cathode chamber 22 is 0.2 MPa or more. When two electrolyzers 2 are used as illustrated in FIG. 2 and the water supplied to the anode chamber 21 is water that is substantially free from a mineral component, the concentration DH of hydrogen water is 1.6 mg/L or more with the setting in which the current flowing through each cathode 24 is 6 A or more, the supply amount of water to the cathode chamber 22 is 1.0 L/min or less, and the pressure of water supplied to the cathode chamber 22 is 0.1 MPa or more, or with the setting in which the current flowing through each cathode 24 is 6 A or more, the supply amount of water to the cathode chamber 22 is 2.0 L/min or less, and the pressure of water supplied to the cathode chamber 22 is 0.2 MPa or more.

When one electrolyzer 2 is used as illustrated in FIG. 1 and the water supplied to the anode chamber 21 is water that contains a mineral component, the concentration DH of hydrogen water is 1.6 mg/L or more with the setting in which the current flowing through the cathode 24 is 6 A or more, the supply amount of water to the cathode chamber 22 is 1.0 L/min or less, and the pressure of water supplied to the cathode chamber 22 is 0.3 MPa or more. When two electrolyzers 2 are used as illustrated in FIG. 2 and the water supplied to the anode chamber 21 is water that contains a mineral component, the concentration DH of hydrogen water is 1.6 mg/L or more with the setting in which the current flowing through each cathode 24 is 6 A or more, the supply amount of water to the cathode chamber 22 is 1.0 L/min or less, and the pressure of water supplied to the cathode chamber 22 is 0.1 MPa or more, or with the setting in which the current flowing through each cathode 24 is 6 A or more, the supply amount of water to the cathode chamber 22 is 2.0 L/min or less, and the pressure of water supplied to the cathode chamber 22 is 0.2 MPa or more.

Then, hydrogen concentration DH (mg/L) and pH of water generated in the cathode chamber 22 were measured over time when using the Kamakura city tap water (calcium hardness of 42.5 ppm and magnesium hardness of 18.5 ppm as the U.S. water hardness and pH 7.01) as the water containing a mineral component, using the hydrogen water generator 1 of FIG. 1 having one electrolyzer 2, storing the tap water in the anode chamber 21 (closing the valve 92), setting the current flowing through the cathode 24 at 6 A, setting the flow rate of water in the cathode chamber 22 at 1 L/min, and setting the water pressure in the cathode chamber 22 at 0.2 MPa. Results are listed in Table 2.

TABLE 2

| | Anode water = Tap water flowing | | | | |
|---|---|---|---|---|---|
| | Anode chamber inner pressure = Cathode | Cathode water | Cathode inner | DH | |
| Current | chamber inner pressure | flow rate | pressure (MPa) | (mg/L) | pH |
| 6 A × 1 bath | When flowing water at flow rate of 1.0 L/min | 1.0 L/min | 0.2 | 1.8 | 8.50 |
| | Immediately after stopping water supply | | | 1.8 | 8.41 |
| | 1 min after stopping water supply | | | 1.8 | 7.21 |
| | 3 min after stopping water supply | | | 1.9 | 7.03 |

### <<Consideration>>

While the tap water is flowing through the anode chamber 21 at a flow rate of 1.0 L/min, pH of the hydrogen water is about 8.50, that is, alkaline, but pH comes close to neutrality immediately after stopping the water flow. When one minute has passed after stopping the water flow, pH is 7.2, that is, neutral. When three minutes have passed after stopping the water flow, pH is 7.03, that is, neutral.

Then, hydrogen concentration DH (mg/L) and pH of water generated in the cathode chamber 22 were measured when using the Kamakura city tap water (calcium hardness of 42.5 ppm and magnesium hardness of 18.5 ppm as the U.S. water hardness and pH 7.04) as the water containing a mineral component, using the hydrogen water generator 1 of FIG. 3 having one electrolyzer 2, supplying purified water, 0.01% calcium sulfate solution, and 0.1% calcium sulfate solution to the space between the anode 23 and the cation exchange membrane 25, setting the current flowing through the cathode 24 at 6 A, setting the flow rate of water in the cathode chamber 22 at 1 L/min, and setting the water pressure in the cathode chamber 22 at 0.2 MPa. Results are listed in Table 3.

TABLE 3

| | | Cathode water | Cathode inner | DH | |
|---|---|---|---|---|---|
| Current | Between anode and membrane | flow rate | pressure (MPa) | (mg/L) | pH |
| 6 A × 1 bath | Purified water sprayed | 1.0 L/min | 0.2 | 1.6 | 6.98 |
| | 0.01% calcium sulfate solution | | | 1.6 | 7.10 |
| | 0.1% calcium sulfate solution | | | 1.6 | 7.05 |

### <<Consideration>>

When the hydrogen water generator illustrated in FIG. 3 is used and the space between the anode 23 and the cation exchange membrane 25 is supplied with any of the purified water and the water which contains a mineral component, neutral hydrogen water of DH=1.6 is obtained

Then, hydrogen concentration DH (mg/L) and pH of water generated in the cathode chamber 22 were measured when using the Kamakura city tap water (calcium hardness of 42.5 ppm and magnesium hardness of 18.5 ppm as the U.S. water hardness and pH 7.1) as the water containing a mineral component, using the hydrogen water generator 1 of FIG. 2 having two electrolyzers 2, setting the current flowing through each cathode 24 at 6 A, setting the flow rate of water in the cathode chamber 22 at 1 L/min, setting the water pressure in the cathode chamber 22 at 0.2 MPa, leaving the hydrogen water generator 1 for two days so that the mineral component would attach to the cation exchange membrane 25, the anode 23, and the cathode 24, generating hydrogen water for five minutes using the hydrogen water generator 1, then performing reverse washing with a reversed DC voltage for 30 seconds, and returning the polarity to the original state to generate hydrogen water for one minute. Measurement results are listed in Table 4.

TABLE 4

| | Anode water = Tap water flowing | | Cathode inner | | |
|---|---|---|---|---|---|
| | Anode chamber inner pressure = Cathode | Cathode water | pressure | DH | |
| Current | chamber inner pressure | flow rate | (MPa) | (mg/L) | pH |
| 6 A × 2 baths | Immediately after water supply | 1 L/min | 0.2 | — | 10.44 |
| | 1 min after water supply | | | 2.5 | 9.55 |
| | 2 min after water supply | | | — | 9.19 |
| | 3 min after water supply | | | 2.8 | 8.95 |
| | 4 min after water supply | | | — | 8.72 |
| | 5 min after water supply | | | 2.3 | 8.72 |

Reverse washing for 30 seconds (Passing tap water
through anode chamber and cathode chamber at 1 L/min.
Anode chamber inner pressure = Cathode chamber inner pressure)

| | | | | | |
|---|---|---|---|---|---|
| 6 A × 2 baths | 1 min after water supply | 1 L/min | 0.2 | 2.6 | 9.54 |

### <<Consideration>>

When the hydrogen water generator is activated after being left for a long time, highly-alkaline hydrogen water is generated immediately after water supply, but pH decreases in about four minutes. However, the reverse washing is performed to remove the mineral component attached to the cathode 24, highly alkaline hydrogen water is generated again.

Then, hydrogen concentration DH (mg/L) and pH of water generated in the cathode chamber 22 were measured when using the Kamakura city tap water (calcium hardness of 42.5 ppm and magnesium hardness of 18.5 ppm as the U.S. water hardness and pH 7.08) as the water containing a mineral component, using the hydrogen water generator 1 of FIG. 1 having one electrolyzer 2, setting the flow rate of tap water supplied to the anode chamber 21 at 0.5 L/min, 1.0 L/min, and 1.5 L/min, setting the current flowing through the cathode 24 at 6 A, setting the flow rate of water in the cathode chamber 22 at 1 L/min, and setting the water pressure in the cathode chamber 22 at 0.2 MPa. Results are listed in Table 5.

TABLE 5

| | Cathode | Cathode inner | Anode | Anode inner | | |
|---|---|---|---|---|---|---|
| | water flow | pressure | water flow | pressure | DH | |
| Current | rate | (MPa) | rate | (MPa) | (mg/L) | pH |
| 6 A × 1 bath | 1.0 L/min | 0.2 | 0 (Water supply | 0 | 1.7 | 7.07 |
| | | | stopped) | | | |
| | | | 0.005 L/min | 0.2 | 1.6 | 7.06 |
| | | | 0.5 L/min | 0.2 | 1.7 | 7.67 |
| | | | 1.0 L/min | 0.2 | 1.6 | 8.16 |
| | | | 1.5 L/min | 0.2 | 1.6 | 9.78 |

### <<Consideration>>

The hydrogen water delivered from the cathode chamber 22 becomes highly alkaline by adjusting the flow rate of water supplied to the anode chamber 21 which contains a mineral component, that is, by increasing the flow rate of water supplied to the anode chamber 21 which contains a mineral component (so that, for example, the ratio of the flow rate in the anode chamber 21 to the flow rate in the cathode chamber 22 is one or more) while, in contrast, the hydrogen water delivered from the cathode chamber 22 becomes neutral or comes close to neutrality by reducing the flow rate of water supplied to the anode chamber 21 which contains a mineral component (so that, for example, the ratio of the flow rate in the anode chamber 21 to the flow rate in the cathode chamber 22 is less than one). In particular, when the flow rate in the anode chamber 21 is reduced to generate neutral hydrogen water, the drainage water from the anode chamber 21 (discharge amount) can be reduced. When generating alkaline hydrogen water, it may be delivered after being mixed with the hydrogen water generated in the cathode chamber 22 in order to save the effort of discharge.

Then, hydrogen concentration DH (mg/L) and pH of water generated in the cathode chamber 22 of the second-stage electrolyzer 2 were measured when using the Kamakura city tap water (calcium hardness of 42.5 ppm and magnesium hardness of 18.5 ppm as the U.S. water hardness and pH 7.08) as the water containing a mineral component, using the hydrogen water generator 1 of FIG. 2B having two electrolyzers 2, setting the flow rate of tap water supplied to the anode chamber 21 of the second-stage electrolyzer 2 at 0.43 L/min, setting the current flowing through the cathode 24 of the first-stage electrolyzer 2 at 1.5 A, setting the current flowing through the cathode 24 of the second-stage electrolyzer 2 at 6 A, setting the flow rate of water in the cathode chamber 22 of the second-stage electrolyzer 2 at 1 L/min, and setting the water pressure in the cathode chamber 22 of the second-stage electrolyzer 2 at 0.2 MPa. Results are listed in Table 6.

TABLE 6

| | Cathode | Cathode inner | Anode | Anode inner | | |
|---|---|---|---|---|---|---|
| | water flow | pressure | water flow | pressure | DH | |
| Current | rate | (MPa) | rate | (MPa) | (mg/L) | pH |
| First-stage electrolyzer: 1.5 A | 1.0 L/min | 0.2 | 0.43 L/min | 0.2 | 1.6 | 9.58 |
| Second-stage electrolyzer: 6 A | | | | | | |

### <<Consideration>>

In the hydrogen water generator of Table 1 having one electrolyzer, the condition for increasing both the hydrogen concentration and the alkalinity is limited, but according to this example, highly-alkaline hydrogen water having a saturated hydrogen concentration can be generated.

### DESCRIPTION OF REFERENCE NUMERALS

1 Hydrogen water generator
2 Electrolyzer
20 Housing
21 Anode chamber
211 Inlet for water for electrolysis Wa
212 Outlet for water for electrolysis Wa
22 Cathode chamber
221 Inlet for water for electrolysis Wc
222 Outlet for water for electrolysis Wc
23 Anode
24 Cathode
25 Membrane
3 Electric power source
31 Plug
32 AC/DC converter
4 First supply system
41 Tap water source
42 Pipework
43 Opening/closing valve
5 Water delivery system
51 Pipework (Gas-liquid mixing pipe)
52 Dissolution part
53 Flow rate regulating valve
54 Water delivery outlet
6 Second supply system
61 Tank
62 Pipework
63 Pump
7 Third supply system
71 Pipework
8 Switch
9 Drain system
91 Pipework
92 Opening/closing valve
Wa, Wc Water for electrolysis

1. A method of generating hydrogen water of pH 6 to 8 using at least one electrolyzer, the at least one electrolyzer comprising: a housing; a membrane that partitions an inside of the housing; an anode chamber and a cathode chamber that are formed inside the housing by being partitioned by the membrane; an anode that is provided to be in contact with a surface of the membrane at the anode chamber side or provided to be separated from the surface via a small space; and a cathode that is provided to be in contact with a surface of the membrane at the cathode chamber side or provided to be separated from the surface of the membrane at the cathode chamber side via a small space,
the method comprising:
continuously supplying the cathode chamber with water that contains a mineral component;
supplying the anode chamber with water that does not contain a mineral component of which an amount exceeds an impurity content;
applying a DC voltage between the anode and the cathode; and
delivering hydrogen water generated in the cathode chamber.

2. The method of generating hydrogen water according to claim 1, wherein
the at least one electrolyzer comprises an electrolyzer, and
the hydrogen water is generated under a condition in which a current flowing through the cathode is 6 A or more, a supply amount of water to the cathode chamber is 1.0 L/min or less, and a pressure of water supplied to the cathode chamber is 0.2 MPa or more.

3. The method of generating hydrogen water according to claim 1, wherein
the at least one electrolyzer comprises two electrolyzers, and
the hydrogen water is generated under a condition in which a current flowing through each cathode is 6 A or more, a supply amount of water to the cathode chamber is 1.0 L/min or less, and a pressure of water supplied to the cathode chamber is 0.1 MPa or more or under a condition in which the current flowing through each cathode is 6 A or more, the supply amount of water to the cathode chamber is 2.0 L/min or less, and the pressure of water supplied to the cathode chamber is 0.2 MPa or more.

4. A method of generating hydrogen water of pH 6 to 8 using at least one electrolyzer, the at least one electrolyzer comprising: a housing; a membrane that partitions an inside of the housing; an anode chamber and a cathode chamber that are formed inside the housing by being partitioned by the membrane; an anode that is provided to be in contact with a surface of the membrane at the anode chamber side or provided to be separated from the surface via a small space; and a cathode that is provided to be in contact with a surface of the membrane at the cathode chamber side or provided to be separated from the surface of the membrane at the cathode chamber side via a small space,
the method comprising:
continuously supplying the cathode chamber with water that contains a mineral component;
storing, in the anode chamber, water that contains a mineral component or water that does not contain a mineral component of which an amount exceeds an impurity content;
applying a DC voltage between the anode and the cathode; and
delivering hydrogen water generated in the cathode chamber.

5. The method of generating hydrogen water according to claim 4, wherein
the at least one electrolyzer comprises an electrolyzer, and
the hydrogen water is generated under a condition in which a current flowing through the cathode is 6 A or more, a supply amount of water to the cathode chamber is 1.0 L/min or less, and a pressure of water supplied to the cathode chamber is 0.2 MPa or more.

6. A method of generating hydrogen water of pH 6 to 8 using at least one electrolyzer, the at least one electrolyzer comprising: a housing; a membrane that partitions an inside of the housing from an outside; a cathode chamber that is formed inside the housing by being partitioned by the membrane; an anode that is provided to be in contact with a surface of the membrane located outside the housing or provided to be separated from the surface via a small space; and a cathode that is provided to be in contact with a surface of the membrane at the cathode chamber side or provided to be separated from the surface of the membrane at the cathode chamber side via a small space,
the method comprising:
continuously supplying the cathode chamber with water that contains a mineral component;
supplying at least a space between the anode and the membrane with water that does not contain a mineral component of which an amount exceeds an impurity content or water that contains a mineral component;
applying a DC voltage between the anode and the cathode; and
delivering hydrogen water generated in the cathode chamber.

7. The method of generating hydrogen water according to claim 6, wherein
the at least one electrolyzer comprises an electrolyzer, and
the hydrogen water is generated under a condition in which a current flowing through the cathode is 6 A or more, a supply amount of water to the cathode chamber is 1.0 L/min or less, and a pressure of water supplied to the cathode chamber is 0.2 MPa or more.

8. A method of generating hydrogen water of higher than pH 8 using at least one electrolyzer, the at least one electrolyzer comprising: a housing; a membrane that partitions an inside of the housing; an anode chamber and a cathode chamber that are formed inside the housing by being partitioned by the membrane; an anode that is provided to be in contact with a surface of the membrane at the anode chamber side or provided to be separated from the surface via a small space; and a cathode that is provided to be in contact with a surface of the membrane at the cathode chamber side or provided to be separated from the surface of the membrane at the cathode chamber side via a small space,
the method comprising:
continuously supplying the cathode chamber with water that does not contain a mineral component of which an amount exceeds an impurity content or water that contains a mineral component;
supplying the anode chamber with water that contains a mineral component;
applying a DC voltage between the anode and the cathode; and
delivering hydrogen water generated in the cathode chamber.

9. The method of generating hydrogen water according to claim 8, wherein
the at least one electrolyzer comprises an electrolyzer, and
the hydrogen water is generated under a condition in which a current flowing through the cathode is 6 A or more, a supply amount of water to the cathode chamber is 1.0 L/min or less, and a pressure of water supplied to the cathode chamber is 0.1 MPa or more.

10. The method of generating hydrogen water according to claim 8, wherein
the at least one electrolyzer comprises two electrolyzers, and
the hydrogen water is generated under a condition in which a current flowing through each cathode is 6 A or more, a supply amount of water to the cathode chamber is 1.0 L/min or less, and a pressure of water supplied to the cathode chamber is 0.1 MPa or more or under a condition in which the current flowing through each cathode is 6 A or more, the supply amount of water to the cathode chamber is 2.0 L/min or less, and the pressure of water supplied to the cathode chamber is 0.2 MPa or more.

11. The method of generating hydrogen water according to claim 8, comprising:
applying the DC voltage between the anode and the cathode for an arbitrary time period that exceeds zero and delivering the hydrogen water generated in the cathode chamber;
then applying a reversed DC voltage having a reversed polarity from that of the DC voltage between the anode and the cathode for a predetermined time period; and
applying the DC voltage again between the anode and the cathode and delivering the hydrogen water generated in the cathode chamber.

12. A method of generating hydrogen water using at least one electrolyzer, the at least one electrolyzer comprising: a housing; a membrane that partitions an inside of the housing; an anode chamber and a cathode chamber that are formed inside the housing by being partitioned by the membrane; an anode that is provided to be in contact with a surface of the membrane at the anode chamber side or provided to be separated from the surface via a small space; and a cathode that is provided to be in contact with a surface of the membrane at the cathode chamber side or provided to be separated from the surface of the membrane at the cathode chamber side via a small space,
the method comprising:
continuously supplying the cathode chamber with water that does not contain a mineral component of which an amount exceeds an impurity content or water that contains a mineral component;
supplying the anode chamber with water that contains a mineral component;
applying a DC voltage between the anode and the cathode; and
delivering hydrogen water generated in the cathode chamber,
wherein a flow rate of water supplied to the anode chamber is adjusted.

13. The method of generating hydrogen water according to claim 12, wherein
the flow rate of water supplied to the anode chamber is higher than the flow rate of water supplied to the cathode chamber and hydrogen water of higher than pH 8 is delivered, or
the flow rate of water supplied to the anode chamber is lower than the flow rate of water supplied to the cathode chamber and hydrogen water of pH 6 to 8 is delivered.

14. The method of generating hydrogen water according to claim 12, wherein
the flow rate of water supplied to the anode chamber is set at a value that exceeds zero and hydrogen water of higher than pH 8 is delivered, or
the flow rate of water supplied to the anode chamber is set at zero and hydrogen water of pH 6 to 8 is delivered.

15. A method of generating hydrogen water, comprising:
preparing at least one electrolyzer comprising: a housing; a membrane that partitions an inside of the housing; an anode chamber and a cathode chamber that are formed inside the housing by being partitioned by the membrane; an anode that is provided to be in contact with a surface of the membrane at the anode chamber side or provided to be separated from the surface via a small space; and a cathode that is provided to be in contact with a surface of the membrane at the cathode chamber side or provided to be separated from the surface of the membrane at the cathode chamber side via a small space;
supplying the cathode chamber with water of higher than pH 8, the water being generated by electrolysis of water that contains a mineral component;
supplying the anode chamber with water generated by electrolysis of water that contains a mineral component;
applying a DC voltage between the anode and the cathode; and
delivering hydrogen water generated in the cathode chamber.
